(19) United States
(12) Patent Application Publication
(10) Pub. No.: US 2007/0181370 A1
(43) Pub. Date: Aug. 9, 2007

(54) Stabilized ladder

(76) Inventor: Stephen Kemp-Banks, Sittingbourne (GB)

Correspondence Address: SUNG I. OH, PROFESSIONAL LAW CORPORATION, 710 QUAIL VALLEY LANE, WEST COVINA, CA, 91791, US

(21) Appl. No.: 11/348,115

(22) Filed: Feb. 6, 2006

(51) Int. Cl. E06C 1/00

(52) U.S. Cl. 182/204

(57) ABSTRACT

A ladder is stabilized in a plurality of planes so it will not twist, slide or fall once it is in place. Telescoping legs are mounted on each side rail of the ladder, a cable system acts as a harness rail and an anti-roll bar is mounted on top of each side rail. The cable system allows the harness to be extended on an extension ladder.

### TECHNICAL FIELD OF THE INVENTION

The present invention relates to the general art of ladders, and to the particular field of ladder stabilizers.

### BACKGROUND OF THE INVENTION

Ladders are used extensively in a number of different situations such as construction, painting, building maintenance, etc. A ground supported ladder is generally used in an inclined position with its upper end portion resting on or against a suitable support. When a downwardly directed force is applied to the ladder by someone standing on it there is a nature tendency for the base of the ladder to move in a horizontal direction away from the supporting surface. Most serious accidents involving ladders of this type can be attributed to failure to provide a sound ladder footing. Long straight ladders and particularly extension ladders are inherently unstable when supported on uneven ground.

At times, the surface a ladder needs to be placed on is uneven or inclined. Placement of a ladder on an uneven surface renders the ladder unstable, which increases the possibility of the ladder toppling over, resulting in injury to workers. When such a ladder is used on irregular or sloping surfaces it is common practice to block or shim the ladder to compensate for the irregularity of the supporting surface. This is an extremely dangerous practice, but in many instances the practice cannot be avoided. This is particularly true where there is no provision for adjusting the effective length of the ladder side rails.

A number of devices have been developed to adjust the level of the ladder legs so that the ladder is firmly supported, even when placed on uneven surfaces. However, often, ladders may be unstable in a variety of planes. For example, the ladder may be subject to twisting on the top while subject to slipping in at least two planes on the bottom.

The inventor is not aware of any stabilizing device that can effectively stabilize a ladder, especially an extension ladder, in a multiplicity of planes. Without such effective multi-plane stabilization, there is a danger that the ladder can become unstable.

Accordingly, it is the general objective of the present invention to provide an improved ladder stabilizing unit which will provide a wide support base to assure firm footing for a ladder. It is a further objective of the invention to provide a ladder stabilizing device which may be readily adjusted to compensate for irregularities in the ladder supporting surface and may be adjusted to provide support in a variety of different planes.

Storage of ladders is another important consideration. A ladder is generally a bulky and sizable item and therefore may take up an inordinate amount of storage space. Any item that exacerbates this problem will likely not be successful. Accordingly, there is a need for a ladder stabilizer that can be moved into a position for storage and which will not unduly increase the storage bulk of a ladder.

### SUMMARY OF THE INVENTION

The above-discussed disadvantages of the prior art are overcome by a ladder stabilizer system that supports the ladder, including an extension ladder, in a plurality of planes, including a roll plane, a tilt plane and a fall back plane. The stabilizer system includes an anti-roll bar on the top of each side rail of the ladder, a telescoping anti-slide leg on the bottom of each side rail for stabilizing the ladder in a slide plane with respect to the ladder, and a telescoping anti-fall back leg on the bottom of each side rail for stabilizing the ladder in a fall back plane with respect to the ladder. A safety harness system includes a cable that is mounted on one side rail of the ladder. The cable system permits adapting the harness to the chosen size of an extension ladder, and the harness adds a further safety feature to the ladder.

Using the ladder stabilizer system embodying the present invention will permit stabilization of a ladder, including an extension ladder, in a plurality of planes whereby the ladder is quite secure. The harness system adds further safety features to the stabilized ladder.

Other systems, methods, features, and advantages of the invention will be, or will become, apparent to one with skill in the art upon examination of the following figures and detailed description. It is intended that all such additional systems, methods, features, and advantages be included within this description, be within the scope of the invention, and be protected by the following claims.

### BRIEF DESCRIPTION OF THE DRAWING FIGS.

The invention can be better understood with reference to the following drawings and description. The components in the figures are not necessarily to scale, emphasis instead being placed upon illustrating the principles of the invention. Moreover, in the figures, like referenced numerals designate corresponding parts throughout the different views.

FIG. 1 is a perspective view of a ladder stabilizer embodying the present invention.

FIG. 2 is a side elevational view of the ladder stabilizer shown in FIG. 1.

### DETAILED DESCRIPTION OF THE INVENTION

Referring to the figures, it can be understood that the present invention is embodied in a stabilized ladder unit 10 which is stabilized in a plurality of planes.

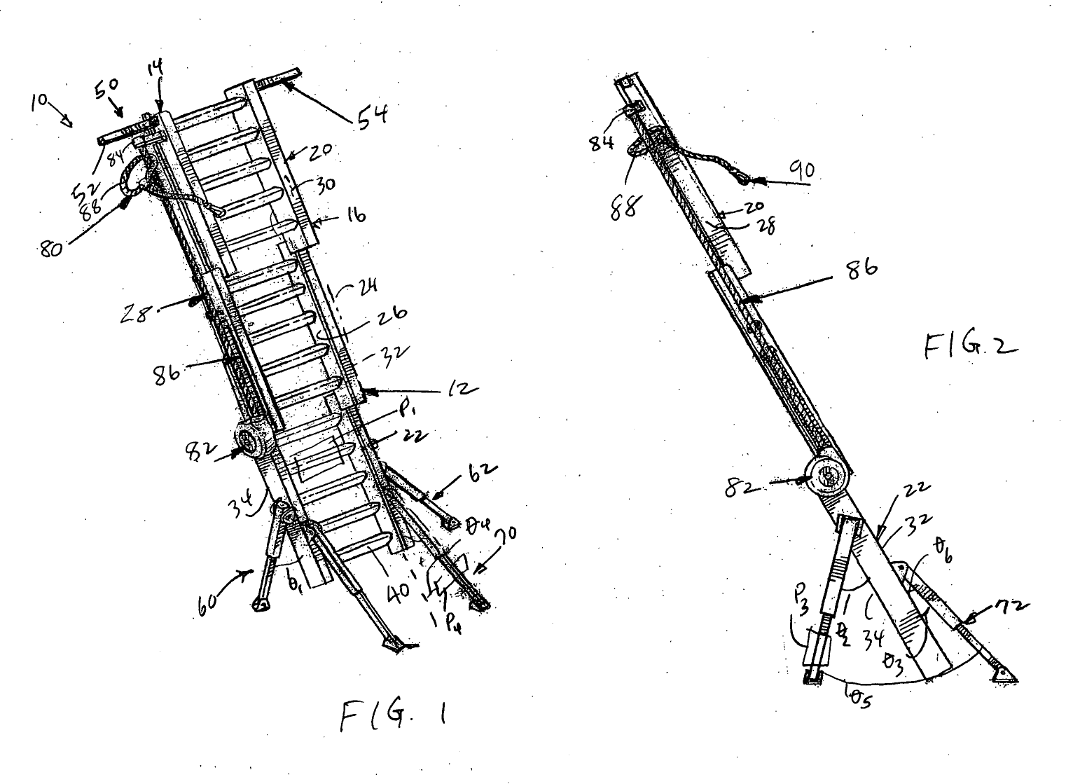

Ladder unit 10 comprises a ladder 12 which can be an extension ladder and includes two side rail units 14 and 16. Each side rail unit includes a plurality of sections which slidably fit together. A first section 20 is a top section when the ladder is in use as shown in FIG. 1 and a second section 22 is a bottom section when the ladder is in use. A longitudinal axis 24 extends between the first section and the second section.

Each section of each side rail has an inner surface 26, an outer surface 28, a longitudinal axis 30 which extends between the direction of longitudinal axis 24, a first side edge 32 which is an upper side edge when the ladder is in use and a second side edge 34 which is a lower side edge when the ladder is in use. A plurality of rungs, such as rung 40, extend between the two side rail units. The rungs are located in a first plane P₁ on each section of the ladder.

An anti-roll unit 50 includes bars 52 and 54. Each bar is mounted on the outer surface of a side rail of the first section of the ladder to extend away from the side rail on which it is mounted in a direction transverse to longitudinal axis 30 of the side rail on which it is mounted. The bars are located in first plane P₁.

An anti-tilt unit 60 includes a telescoping leg, such as telescoping leg 62, pivotally mounted on the outer surface of each side rail of second section 22 of the ladder to extend at an oblique angle θ₁ to side rail on which it is mounted. Each telescoping leg is located in a plane P₃ that is oriented at an oblique angle θ₂ to first plane P₁.

An anti-fall unit 70 includes a telescoping leg, such as telescoping leg 72, pivotally mounted on the upper side edge of each side rail of second section 22 of the ladder to extend at an oblique angle θ₃ to the side rail on which it is mounted. Each telescoping leg is located in a plane P₄ that is oriented at an oblique angle θ₄ to first plane P₄ and at an oblique angle θ₅ to the telescoping leg of the anti-tilt unit mounted on the side rail on which the telescoping leg of the anti-fall unit is mounted and at an oblique angle θ₆with respect to the bars of the anti-roll unit. Multi-planar support is thus provided to the ladder by the above-discussed units.

Further support for a user is provided by a harness unit 80 mounted on the ladder. Harness unit 80 includes a cable housing 82 on one side rail, a cable guide 84 on the outer surface of one side rail of the first section of the ladder, a cable 86 which extends between the cable housing and the cable guide on one side rail of the ladder, a cable loop 88 movably attached to the cable, and a cable grip portion 90 attached to each cable loop. A cable control unit is contained in housing 82 and includes a spring unit or the like to rewind the cable when the ladder is collapsed and to allow the cable to be dispensed as the ladder is extended. A brake unit is also contained in the housing to catch the cable 86 when a sharp pull is exerted thereon in the manner of a motor vehicle seat belt so a user will be able to easily extend and retract the cable, but will have a stable and secure element to catch him if he begins to fall off of the ladder. In one form of the invention, cable 86 is formed of steel. A user wears a harness which connects to cable grip 90 to further secure himself to the ladder.

Use of stabilized ladder unit 10 will be understood by those skilled in the art based on the teaching of the foregoing disclosure. Accordingly, use of unit 10 will be only briefly discussed. A user extends ladder 12 to the desired height, then places anti-roll unit 50 against the support surface. The user then extends the legs of the anti-tilt unit 60 and the legs of the anti-fall back unit 70 to stabilize the ladder in two more planes. The user then ascends the ladder and connects his harness to grip portions 90. Cables 86 unwind from housings 82 as the sections of the ladder are extended, and will rewind under spring bias or the like as the sections are collapsed for storage. The pivotal connections of the legs will permit the legs to be moved into the most desirable orientation for supporting the ladder and to be moved into a storage position next to the ladder when the ladder is to be stored so the ladder occupies the least volume during storage.

While various embodiments of the invention have been described, it will be apparent to those of ordinary skill in the art that many more embodiments and implementations are possible within the scope of this invention. Accordingly, the invention is not to be restricted except in light of the attached claims and their equivalents.

What is claimed is:

1. A stabilized ladder unit comprising:
A) a ladder which includes
(1) two side rail units, each side rail unit including
(a) a plurality of sections which slidably fit together,
(b) a first section which is a top section when the ladder is in use,
(c) a second section which is a bottom section when the ladder is in use,
(c) a longitudinal axis which extends between the first section and the second section, and
(e) each section having an inner surface, an outer surface, a longitudinal axis which extends between the direction of the longitudinal axis, a first side edge which is an upper side edge when the ladder is in use and a second side edge which is a lower side edge when the ladder is in use, and
(2) a plurality of rungs which extend between the two side rail units, the rungs being located in a first plane on each section of the ladder;
B) an anti-roll unit which includes a bar mounted on the outer surface of each side rail of the first section of the ladder to extend away from the side rail on which it is mounted in a direction transverse to the longitudinal axis of the side rail on which it is mounted, the bars being located in the first plane;
C) an anti-tilt unit which includes a telescoping leg pivotally mounted on the outer surface of each side rail of the second section of the ladder to extend at an oblique angle to side rail on which it is mounted, each telescoping leg being located in a plane that is oriented at an oblique angle to the first plane;
D) an anti-fall unit which includes a telescoping leg pivotally mounted on the upper side edge of each side rail of the second section of the ladder to extend at an oblique angle to the side rail on which it is mounted, each telescoping leg being located in a plane that is oriented at an oblique angle to the first plane and at an oblique angle to the telescoping leg of the anti-tilt unit mounted on the side rail on which the telescoping leg of the anti-fall unit is mounted and at an oblique angle with respect to the bars of the anti-roll unit; and
E) a harness unit mounted on the ladder and including
(1) a cable housing on one side rail,
(2) a cable guide on the outer surface of one side rail of the first section of the ladder,
(3) a cable which extends between the cable housing and the cable guide on one side rail of the ladder,
(4) a cable loop movably attached to the cable, and
(5) a cable grip portion attached to the cable loop.

2. A stabilized ladder comprising:
A) two side rails and a plurality of rungs extending between the side rail, the rungs being located in a first plane;
B) an anti-twist unit which includes a bar that extends outward from each of the side rails in the first plane;
C) an anti-tilt unit which includes a telescoping leg pivotally mounted on each side rail, each telescoping leg of the anti-tilt unit being oriented to be at an oblique angle with respect to the first plane and at an oblique angle with respect to the bars of the anti-twist unit; and
D) an anti-fall back unit which includes a telescoping leg pivotally mounted on each side rail, each telescoping leg of the anti-fall back unit being oriented to be at an oblique angle with respect to the first plane and at an oblique angle with respect to the telescoping legs of the anti-tilt unit and at an oblique angle with respect to the bars of the anti-twist unit.

3. The stabilized ladder of claim 2, including a harness unit which includes a cable mounted on one side rail, and a cable grip movably attached to the cable.

4. The stabilized ladder of claim 3, where the cable grip includes a cable loop that is movable along the cable.
